(19) United States
(12) Patent Application Publication
(10) Pub. No.: US 2026/0018659 A1
(43) Pub. Date: Jan. 15, 2026

(54) SOLID ELECTROLYTE COMPRISING HALIDE, PREPARATION METHOD THEREOF AND SECONDARY BATTERY COMPRISING THE SAME

(71) Applicants: Lotte Energy Materials Corporation, Jeollabuk-do (KR); SEOUL NATIONAL UNIVERSITY R&DB FOUNDATION, Seoul (KR)

(72) Inventors: Jongho RYU, Jeollabuk-do (KR); Joohyeon NOH, Jeollanam-do (KR); Takrae HA, Jeollabuk-do (KR); Jeonghyun LEE, Jeollabuk-do (KR); Kisuk KANG, Seoul (KR); Joonwoo PARK, Jeollabuk-do (KR); Seungju YU, Seoul (KR)

(21) Appl. No.: 18/930,113

(22) Filed: Oct. 29, 2024

(30) Foreign Application Priority Data
Jul. 12, 2024 (KR) 10-2024-0092504

(51) Int. Cl. H01M 10/0562; H01M 10/052

(52) U.S. Cl. CPC H01M 10/0562; H01M 10/052; H01M 2300/008

(57) ABSTRACT

Disclosed is a novel halide-based solid electrolyte composition exhibiting enhanced ionic conductivity, wherein the solid electrolyte composition comprises a lithium yttrium halide with a hexagonal close-packed structure, and when the occupancy of metal ions is defined as the number of metal ions relative to the number of metal ion sites within two consecutive layers constituting a unit cell with a hexagonal close-packed structure in the halide, the sum of the occupancies of metal ions within the two layers is 0.888 or less.

### CROSS-REFERENCE TO RELATED APPLICATION

This application is based on and claims priority under 35 U.S.C. 119 to Korean Patent Application No. 10-2024-0092504, filed on Jul. 12, 2024, in the Korean Intellectual Property Office, the disclosure of which is herein incorporated by reference in its entirety.

### FIELD

The present disclosure relates to a solid electrolyte containing a halide and, more specifically, to a novel halide-based solid electrolyte exhibiting enhanced ionic conductivity, a preparation method therefor, and a secondary battery including the same.

### BACKGROUND

Semi-solid-state or all-solid-state batteries with solid electrolytes partially or completely replacing liquid electrolytes are attracting increasing interest and research.

However, the solid electrolytes are required to have excellent interfacial characteristics between electrolyte layers containing the same and active material layers and, furthermore, superior contact characteristics between solid electrolytes and active material particles, along with high lithium ionic conductivity comparable to those of liquid electrolytes.

Various solid electrolytes meeting these requirements have been continuously searched for since before, and for example, sulfide-based solid electrolytes, oxide-based solid electrolytes, and halide-based solid electrolytes have been proposed.

Sulfide-based solid electrolytes have the advantages of facilitating the induction of close contact between solid electrolytes and active material particles due to their excellent flexibility compared with oxide-based solid electrolytes and having relatively excellent lithium ionic conductivity, but have the disadvantages of being less stable when exposed to moisture or oxygen in the air and presenting challenges in the battery manufacturing process. Additionally, oxide-based solid electrolytes have the disadvantages of having difficulty in securing excellent contact properties between solid electrolytes and active materials and showing insufficient ionic conductivity.

In recent years, halide-based solid electrolytes exhibiting excellent stability and a predetermined level of ionic conductivity have been proposed to solve the disadvantages of the sulfide- or oxide-based solid electrolytes.

Most of the halide-based solid electrolytes have a layered structure, a rock-salt structure, or a similar structure. Out of these, particularly, hcp-Li₃YCl₆-based solid electrolytes have various compositions with multiple components, such as Zr and lanthanides, being substituted or added.

These halide-based solid electrolytes are known to exhibit high levels of ionic conductivity due to mechanochemical synthesis, but the mechanisms thereof have not been revealed, so that it has not yet reached a level where the ionic conductivity of halide-based solid electrolytes can be controlled or halide solid electrolytes with high ionic conductivity are freely designed.

### PRIOR ART DOCUMENTS

### Patent Documents

(1) KR 10-2023-0092885 A
(2) JP 2023-519758 A

### SUMMARY

The present disclosure has been made to solve the foregoing problems, and an aspect of the present disclosure is to provide a novel halide composition capable of optimizing the ionic conductivity of halide-based solid electrolytes.

Another aspect of the present disclosure is to provide a composition of a halide (lithium yttrium chloride) with a hexagonal close-packed structure, in which a trivalent metal ion is substituted with a tetravalent metal ion, with a suppressed lithium reduction.

Still another aspect of the present disclosure is to provide a halide (lithium yttrium chloride) with a hexagonal close-packed structure, in which the occupancy of metal ions within a layer is limited.

Still another aspect of the present disclosure is to provide a lithium secondary battery including the above-described halide as a solid electrolyte.

In accordance with an aspect of the present disclosure, there is provided a solid electrolyte composition containing a lithium yttrium halide with a hexagonal close-packed structure, wherein when the occupancy of metal ions is defined as the number of metal ions relative to the number of metal ion sites within two consecutive layers constituting a unit cell with a hexagonal close-packed structure in the halide, the sum of the occupancies of metal ions within the two layers is 0.888 or less.

In the present disclosure, the occupancy of metal ions within each layer is preferably 0.444 or less.

Additionally, the halide may include a halide with a hexagonal close-packed structure expressed by Li₃₋ₐ(Y₁₋₍₄₋₄ₓ₎A_{3-3x+(a/4)})Cl₆ (A is a tetravalent cation, x ranges from 0.75 to (0.888-a/4), and a ranges from 0 to 0.552).

In the present disclosure, A may include at least one element selected from the group consisting of Ti, Zr, Hf, and Rf.

In the present disclosure, the halide may include (1-x) moles of vacancies in the crystalline structure.

In accordance with another aspect of the present disclosure, there is provided a lithium secondary battery including the above-described solid electrolyte as an electrode layer.

According to the present disclosure, a halide-based solid electrolyte composition having high ionic conductivity can be provided.

Furthermore, the present disclosure can provide a halide with a hexagonal close-packed structure with enlarged ion conduction paths by limiting the metal occupancy within a layer.

### BRIEF DESCRIPTION OF THE DRAWINGS

The above and other aspects, features and advantages of the present disclosure will be more apparent from the following detailed description taken in conjunction with the accompanying drawings.

FIG. 1A shows the crystalline structure of hcp-Li₃YCl₆, and

FIGS. 1B, 1C and 1D illustrate possible arrangement models for different types of metal arrangements in the crystalline structure of hcp-Li₃YCl₆.

FIG. 2A exemplifies the ordering of metal ions for each arrangement model, and

FIGS. 2B, 2C, 2D and 2E illustrate the lithium diffusion path at each site.

FIG. 3A is a graph showing the calculation results of the activation barrier according to the ordering of metal ions, and

FIGS. 3B, 3C and 3D illustrate a difference in lithium conductivity path according to the ordering of metal ions.

FIGS. 4A and 4B illustrate the design rule of the halide composition according to an embodiment of the present disclosure.

FIGS. 5A, 5B and 5C illustrate the occupancy of metal ions in each layer and the ionic conductivity path according to the occupancy in a halide composition with a hexagonal close-packed structure.

FIG. 6 is a graph obtained by calculating and plotting a target composition according to an embodiment of the present disclosure and the occupancy in each layer within a unit cell with a hexagonal close-packed structure in the target composition.

FIG. 7 is a table summarizing the compositions of conventional literature plotted in FIG. 6 and sources thereof.

FIG. 8 is a graph showing the X-ray diffraction analysis results of a halide sample manufactured according to an embodiment of the present disclosure.

### DETAILED DESCRIPTION

It is to be noted that in the following description, only the parts necessary for understanding exemplary embodiments of the present disclosure will be described, and descriptions of the other parts will be omitted so as not to deviate from the gist of the present disclosure.

The terms and words used in this description and the appended claims are not to be interpreted in common or lexical meaning but, based on the principle that an inventor can adequately define the meanings of terms to best describe the disclosure, to be interpreted in the meaning and concept conforming to the technical concept of the present disclosure. The features described in exemplary embodiments and drawings shown herein are for merely illustrating one of the most preferable exemplary embodiments but are not intended to represent the technical idea of the present disclosure, and thus the present disclosure may cover various equivalents and modifications which can substitute for the exemplary embodiments at the time of filing the present application.

Herein, a compound defined by mentioning its constituent elements may include compounds where some of the mentioned elements are substituted or additional elements besides the mentioned ones are included. Herein, when referring to a compound by constituent elements, for example, lithium yttrium chloride (or LYC) does not exclusively refer to a ternary compound consisting of lithium, yttrium, and chlorine, but also includes quaternary or higher order compounds that contain one or more other elements substituting some of the metal ions or further contain other interstitial elements within the crystal structure.

Hereinafter, the present disclosure will be described in more detail with reference to drawings.

### A. Halide Solid Electrolyte

A-1. Crystalline Structure of Hcp-Li₃ YCl₆

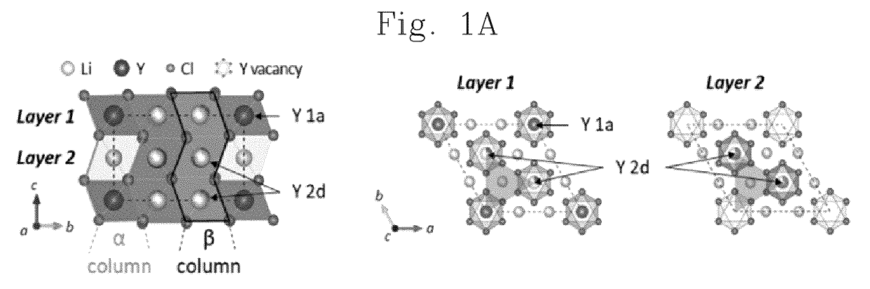

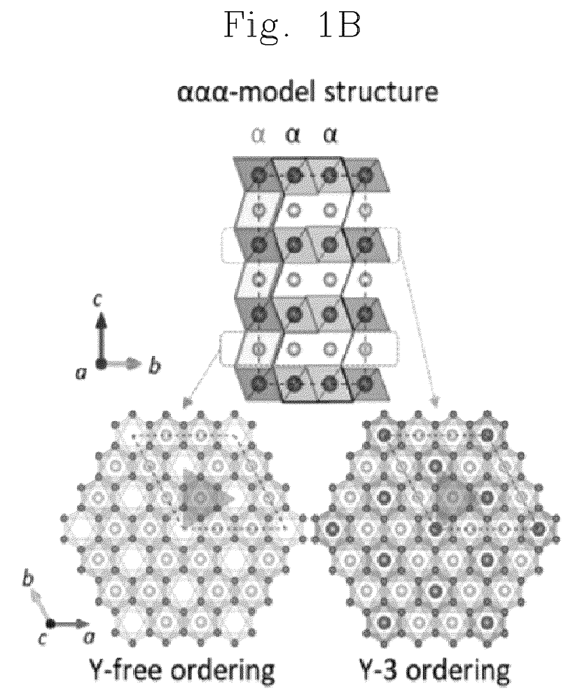

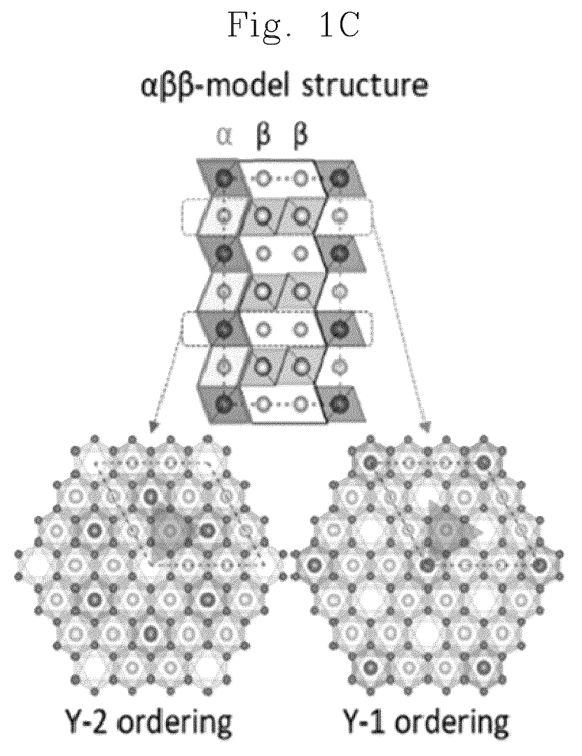

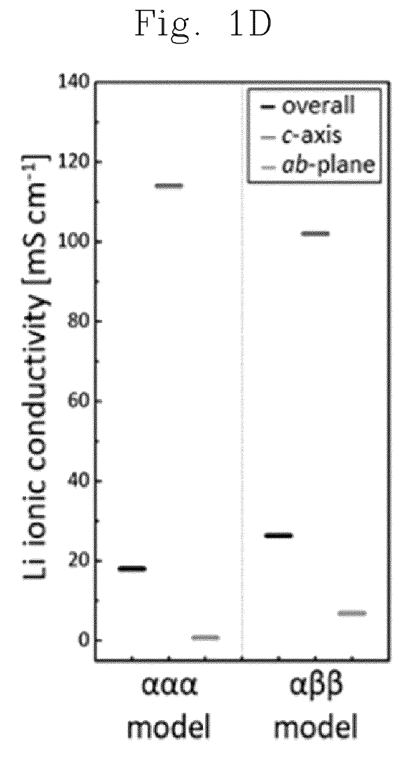

FIG. 1A shows the crystalline structure of hcp-Li₃YCl₆ (hereinafter, hcp-LYC), and FIGS. 1B and 1C show two possible arrangement models, that is, ααα model and βββ model, for different types of metal arrangements in the hcp-LYC structure.

Referring to FIG. 1A, in the exemplary structure of hcp-LYC, the two layers, Layer 1 and Layer 2, are consecutively arranged, and in each layer, CI-ions forms a hexagonal close-packed structure, and lithium ions and metal ions are ordered in octahedral sites formed by CI-ions.

As shown in FIG. 1A, there are a total of two sites where the metal ions can occupy in each layer, of which one is the 1a site located at the vertex of the unit cell and the other is the 2d site located at the center of each layer.

A-2. Layer Structure Modeling and Optimization of Hcp-Li₃ YCl₆

To understand the change tendency of ionic conductivity according to the number and arrangement of metals, two models may be established according to the position of metal ions in the 2d site. Between the two models, one contains the ααα-layer where metal ions are present in both the 2d site and the 1a site as shown in FIG. 1B, and the other contains the αββ-layer where ions in the 2d site and the 1a site are separated by a layer as shown in FIG. 1C. The latter structure may be a most stable arrangement in the hcp-LCY structure.

The ionic conductivity of the overall structure and the ab-plane/c-axis conductivity for the two models were calculated and are shown in FIG. 1D. The ionic conductivity was calculated using ab initio molecular dynamics (AIMD) simulations, with the Vienna ab-initio simulation package (VASP) software used as software.

Referring to FIG. 1D, the αββ model had a higher conductivity.

Noticeably, the overall ionic conductivity of the ααα model is lower than that of the αββ model since, despite having a higher c-axis diffusion rate compared with the αββ model, the ααα model shows a lower diffusion rate in the ab-plane compared with the αββ model. This suggests that the ab-plane diffusion determines the overall ionic conductivity in the corresponding structure. Therefore, the influence of the metal arrangement on the diffusion in the ab-plane needs to be examined.

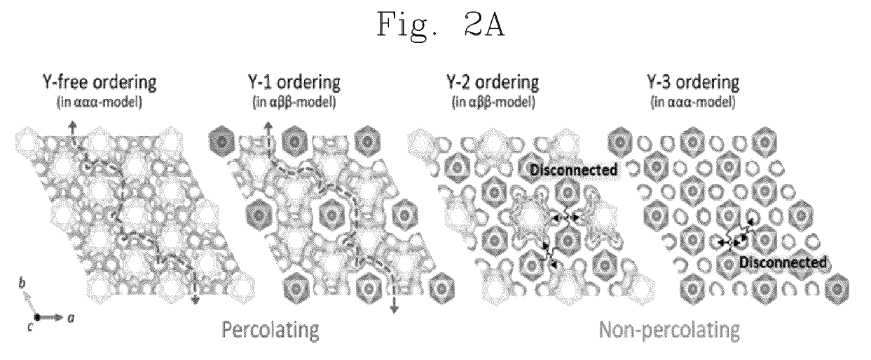

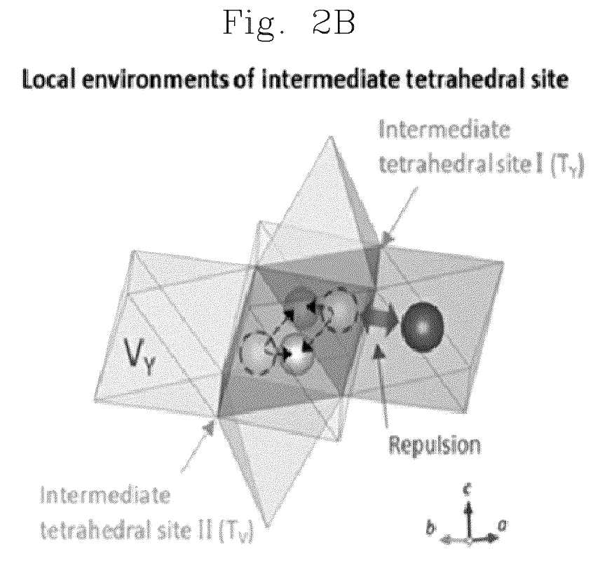

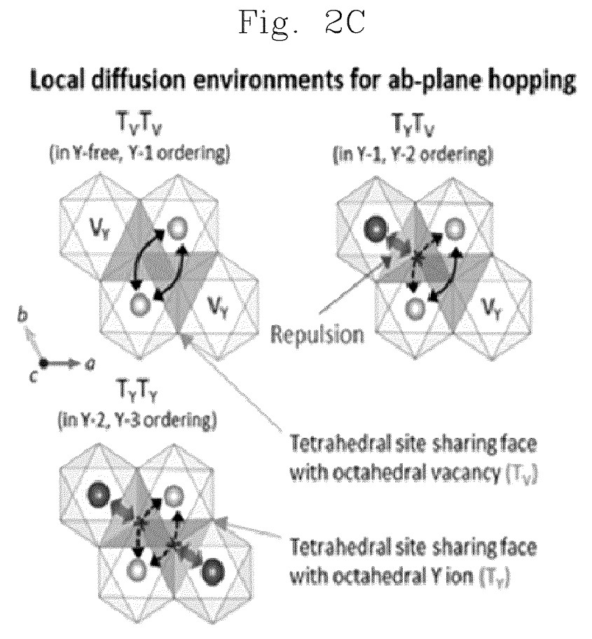

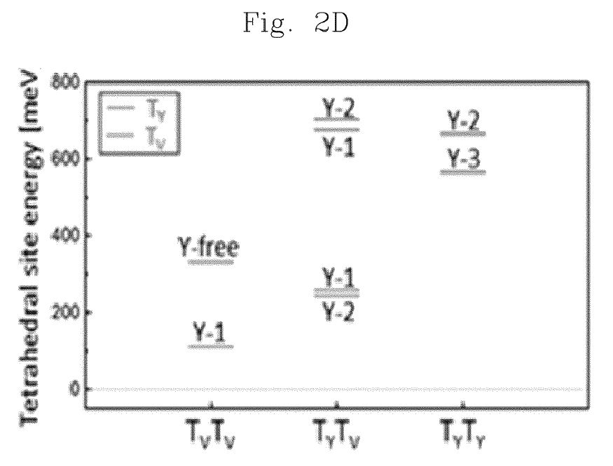

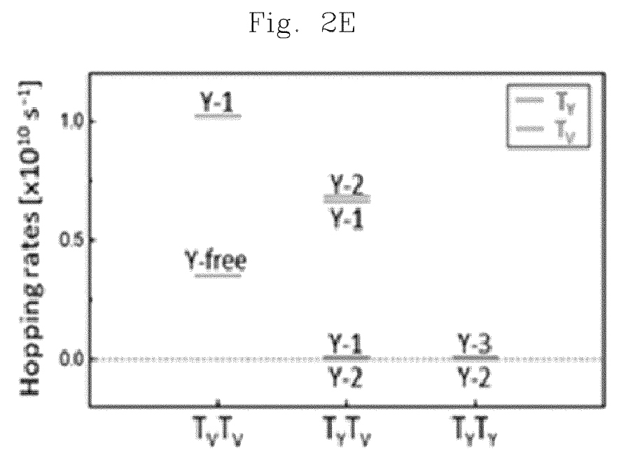

FIG. 2A exemplifies the ordering of metal ions in each model. As shown in FIG. 2A, Y-free ordering and Y-3 ordering are possible in the ααα model, and Y-1 ordering and Y-2 ordering are possible in the αββ model. Particularly, the number following Y indicates the number of metal atoms per unit cell in the ab-plane.

When the layers of each model are individually separated and examined for sites at which Li may be present in the ab-plane, Y-free ordering without no metal ions and Y-1 ordering with one metal ion overall can create an environment that entirely enables Li percolation, and Y-2 ordering and Y-3 ordering may create an environment where Li is isolated among metal ions, resulting in a difficulty in ion diffusion.

FIGS. 2B and 2C illustrate the lithium diffusion path at each site.

Referring to FIGS. 2B and 2C, lithium ions, for migration, need to pass through an intermediate tetrahedral site that is face-shared with an octahedral site that can be occupied by a metal. If the diffusion path when a metal ion is present in the octahedral site is denoted by T_{Y}, and the diffusion path when the octahedral site is vacant is denoted by T_{V}, T_{Y} corresponds to an environment where a lithium ion can hardly pass through due to strong repulsion of the metal ion, whereas T_{V} with no metal ion corresponds to an environment where a lithium ion can easily pass through the tetrahedral site.

The energy and hopping rates required for passing through tetrahedral sites depending on whether octahedral sites are occupied by metal ions were calculated through simulation. The energy was calculated using VASP, and the hopping rates in the simulation results were analyzed using MATLAB program.

FIGS. 2D and 2E are graphs showing the simulation results. Referring the drawings, the presence of metal ions on both sides of the lithium migration path (i.e., T_{Y}T_{Y}) resulted in a low hopping rate since the migration of lithium was difficult due to a very high energy required for passage, while the presence of a metal ion at only one side (that is, T_{V}T_{Y}) enables the migration of lithium ions through Tv with low energy but not T_{Y} with high energy. The absence of metal ions at both sides allowed for the migration of lithium ions through both the paths.

Interestingly, the ion diffusion is faster in T_{V}T_{Y} or T_{Y}T_{V} where one metal ion is present on the lithium path than T_{V}Tᵥ where no metal ion is present on the lithium path. This can be explained as follows.

When comparing a Y-free ordering layer with no metal ion present within one layer with a Y-1 ordering layer with one metal ion present within one layer, the large difference with respect to the lithium conductivity is that the width (i.e., the interlayer distance) of the most critical path for plane diffusion depends on the number of metal ions.

To investigate the effect of interlayer distance on diffusion, the TᵥTᵥ activation barrier was calculated by arbitrarily changing the interlayer distance for each situation. The activation barrier was calculated by the nudged elastic band (NEB) simulation, and VASP was used as software.

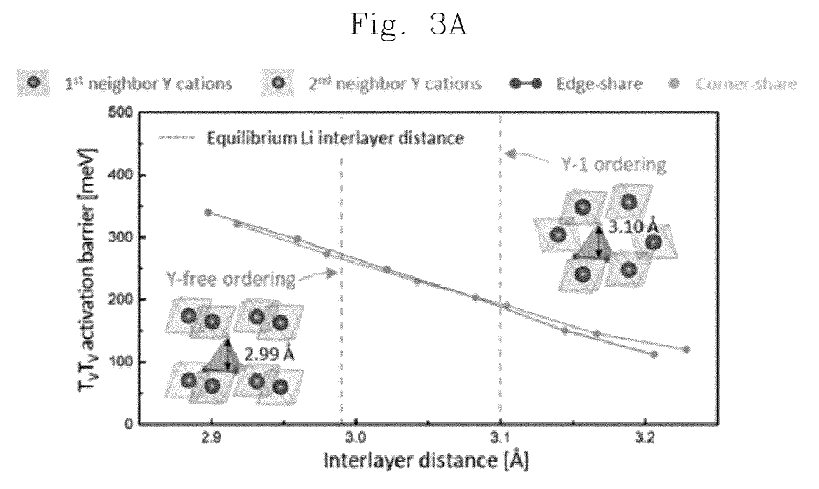

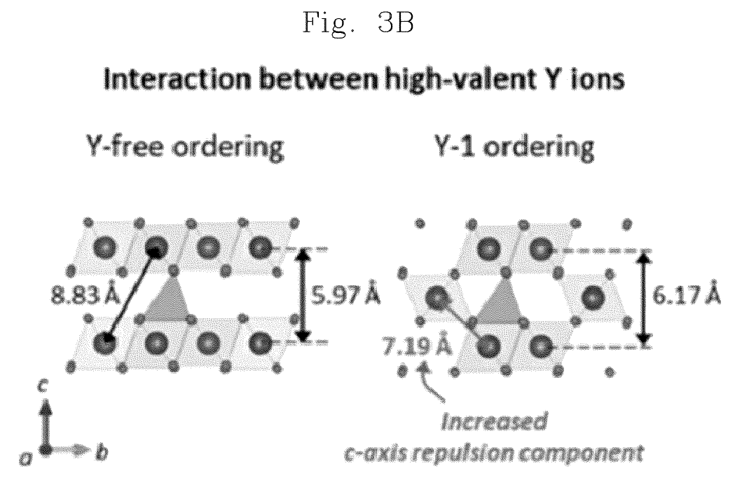

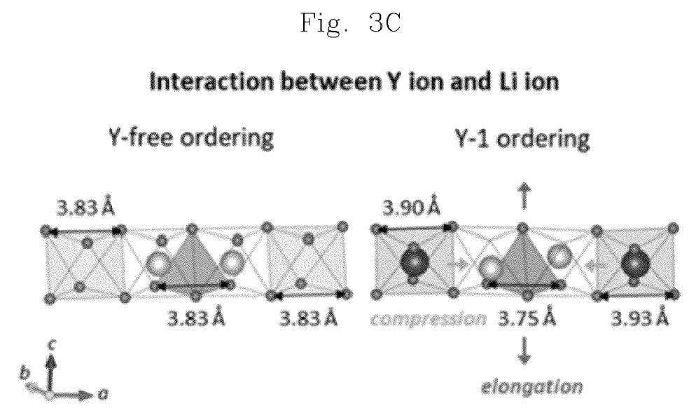

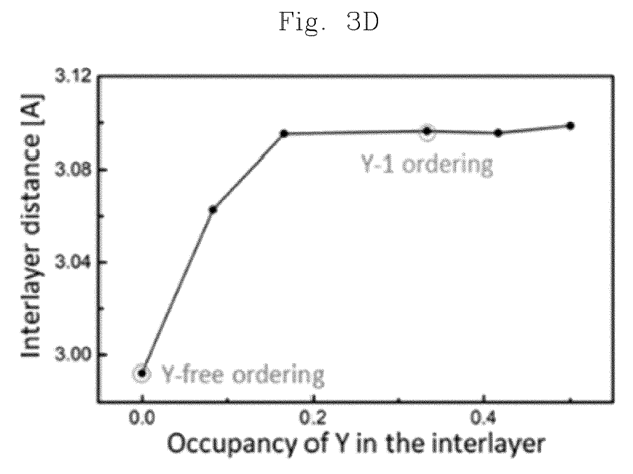

FIG. 3A is a graph showing the calculation results of the TᵥTᵥ activation barrier. It can be confirmed that the TᵥTᵥ activation barrier changes in the same manner according to the interlayer distance, regardless of the presence or absence of metal ions in the layer. It can also be confirmed that the activation barrier in diffusion decreases with increasing interlayer distance.

Meanwhile, the results of calculating the effect of the occupancy of Y on the interlayer distance are shown in FIG. 3D. The corresponding interlayer distances were calculated by analyzing the simulation results of first-principles calculations. VASP was used as software.

Referring to FIG. 3D, the interlayer distance increased until the occupancy of Y reached 0.166, and then became saturated.

In other words, it can be seen that the change in diffusion degree between the Y-free ordering with no metal ion and the Y-1 ordering is attributed to a difference in this interlayer distance, with the path of lithium ions widening to some extent when the number of metal ions is 0.166 or greater.

Additionally, as shown in FIG. 3C, it can be calculated that the presence of Y on the lithium diffusion path results in a distortion in intermediate sites, and this elongation of the tetrahedral site also had an effect on the expansion of the interlayer distance.

FIG. 3B shows that the distance between neighboring Y ions becomes markedly shorter in the Y-1 layer (7.19 Å) than in the Y-free layer (8.83 Å), leading to a stronger c-axis repulsion component between Y ions in adjacent planes, which contributes to an increased interlayer space from 5.97 to 6.17 Å.

### B. Composition of Halide Solid Electrolyte

As described above, the diffusion in the ab-plane can be fast when the environment within a layer enables the percolation of lithium ions and the interlayer distance is sufficiently wide. Meanwhile, a small number of metal ions within a layer is advantageous in percolation, but an appropriate number of metal ions is required to widen the interlayer distance.

The range satisfying the two conditions may be specified as follows. The occupancy of metal ions within each layer preferably has at least a predetermined lower limit value to sufficiently ensure the interlayer distance and at most a predetermined upper limit value to provide percolation within each layer. Preferably, the lower limit value may be 0.166 and the upper limit value may be 0.444 in the present disclosure.

In the present disclosure, the upper limit value may be determined as follows.

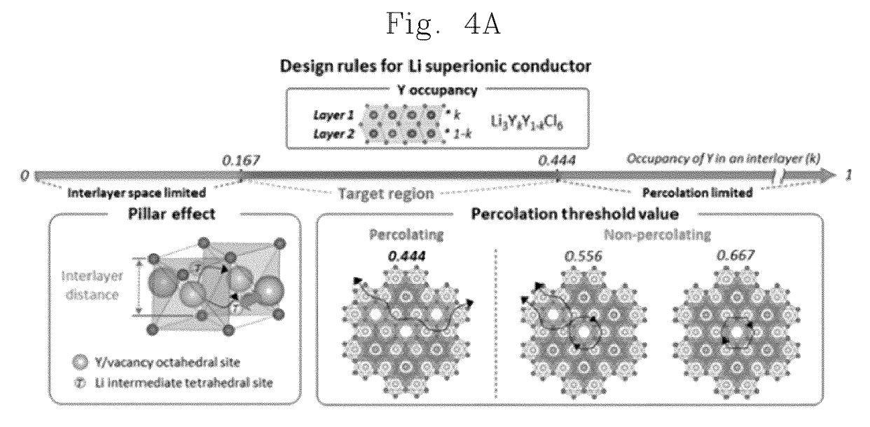

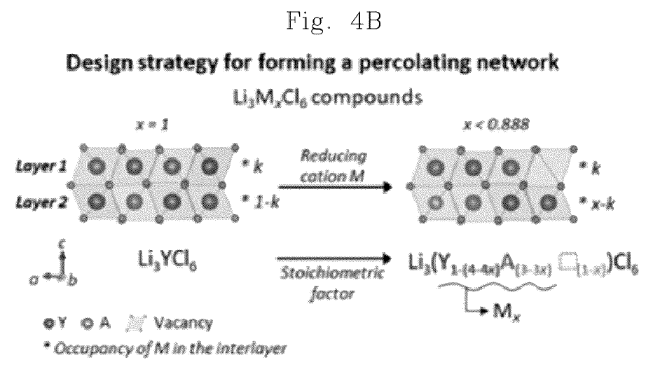

Referring to FIG. 4A, when a hexagonal unit cell is established based on metal ions, the central metal ion needs to be vacant and two metal ions at the vertices of the unit cell need to be vacant in order to allow the percolation of lithium ions, that is, in order for all lithium ions in the hexagonal unit cell to be in the T_{V}T_{Y} or T_{V}T_{V} state. Lithium ions cannot pass through the unit cell at occupancies greater than this level.

FIG. 4A illustrates and shows the calculation design of threshold values for percolation. A hexagonal unit cell contains one central metal ion site and six vertex sites, and the total number of metal ion sites within one unit cell is three since the vertex sites are shared by two adjacent unit cells. The maximum number of metal ions in the unit cell in the threshold state allowing percolation where the central metal ion is vacant and the two vertex metal ions are vacant in the unit cell is (4*1/3), and the occupancy of metal ions may be calculated as ((4*1/3)/3=4/9≈0.444).

Based on these results, the design rule for a state that enables lithium percolation may be determined.

As described above, the hcp-LYC structure is composed of two layers of consecutive arrangements, and in a composition where the metal-to-anion ratio is 1:6, a total of six metal ion sites and a total of three metal ions are present in the two layers. In a composition with a metal-to-anion ratio of 1:6, all the metal ion sites may be occupied by metal ions (e.g., Y-3 ordering), and in such a case, the occupancy may be expressed as 1. Whereas, all metal ion sites in another consecutive layer may be vacant (e.g., Y-free ordering), and in such a case, the occupancy may be expressed as 0. Therefore, each layer in the hcp-LYC structure may have an occupancy of 0 to 1, and if the occupancy of one layer is k, the occupancy of the consecutive layer may be expressed as 1-k. In other words, the sum of the occupancies of two consecutive layers must be 1.

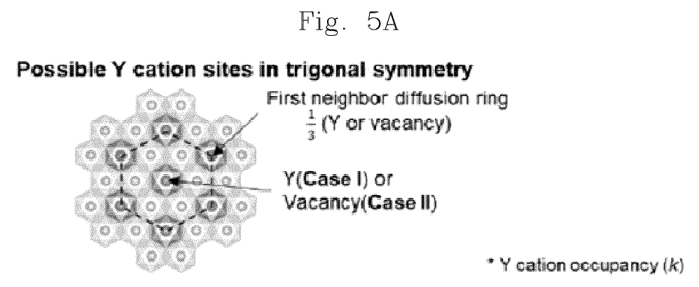

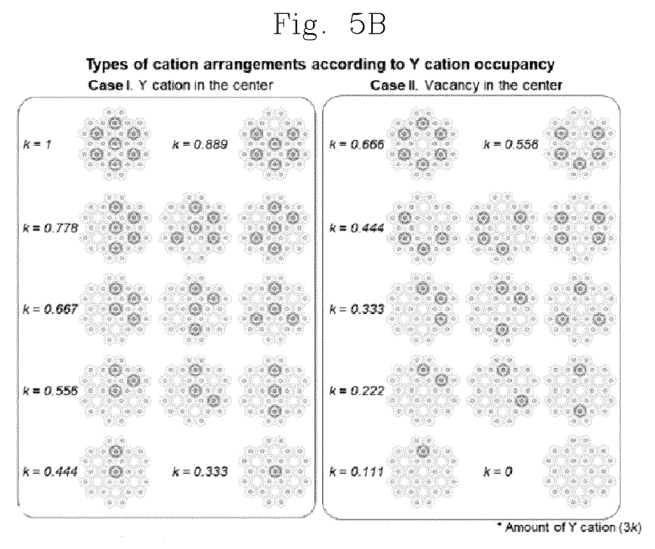

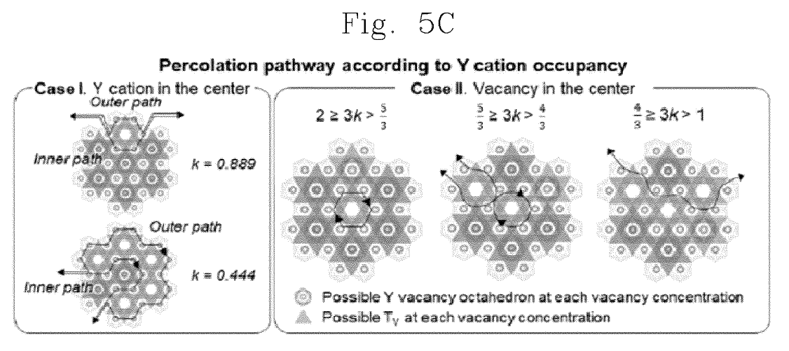

FIG. 5A shows Y ion sites in the hexagonal unit cell. As shown, one central Y ion site and six vertex Y ion sites are present.

In FIG. 5B, CASE I indicates the occupancy k of Y ions depending on the occupation of each vertex when the Y ion site in the center is occupied by Y ion, and CASE II indicates the occupancy k of Y ions depending on the occupation of each vertex when the Y ion site in the center is vacant.

FIG. 5C shows the Li percolation path according to the occupancy k of Y ions.

As described above, the threshold occupancy of one layer allowing ion percolation is 0.444, and if one of two adjacent layers has an occupancy of metal ions of k=0.444, the occupancy of the other consecutive layer, 1-k, must have a value of 0.556 (=1-0.444). In such a case, the other layer is necessarily a non-percolating layer due to the number of metal ions exceeding the threshold value.

In order to achieve high ionic conductivity of the hcp-LYC solid electrolyte, the sum of the occupancies of two adjacent layers needs to be designed to be less than 0.444*2=0.888 since the maximum value of the occupancy of metal ions within the structure is 0.444.

Based on these findings, the inventors of the present disclosure designed a composition capable of achieving high ionic conductivity without changing the number of Li within a unit cell while maintaining the sum of the metal occupancies of two consecutive layers at 0.888 or less.

In other words, the present disclosure provides a hcp-LYC-based solid electrolyte composition, in which the number of metal ions included is decreased to achieve an occupancy of 0.444 or less in individual layers and a sum of occupancies of 0.888 or less in two layers.

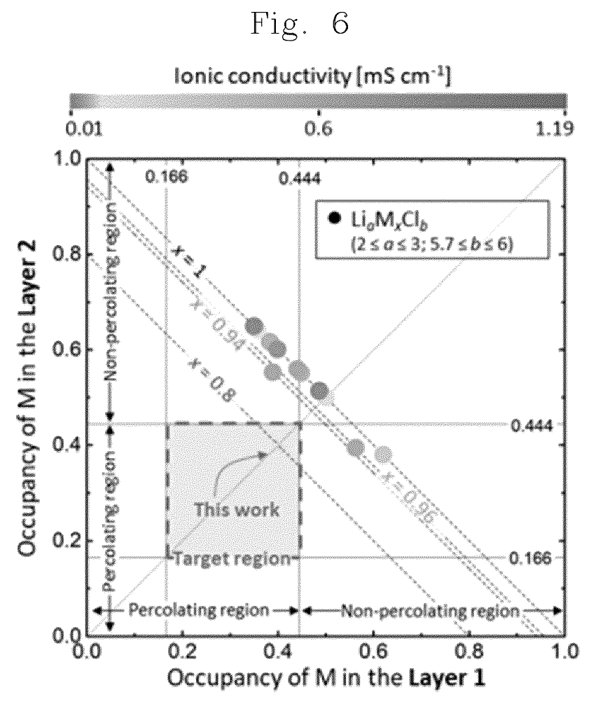

FIG. 6 is a graph obtained by calculating and plotting the occupancies of Layer 1 and Layer 2 in the unit cell for a target composition of the present disclosure and conventional compositions reported in the prior literature. Referring to FIG. 6, the conventional compositions are out of the target region of the present disclosure, with relatively high metal contents. In the formula LiₐMₓCl_{b} shown in FIG. 6, M represents a trivalent or tetravalent ion, such as Y, Ho, Er, or Zr, constituting the hcp-trigonal structure.

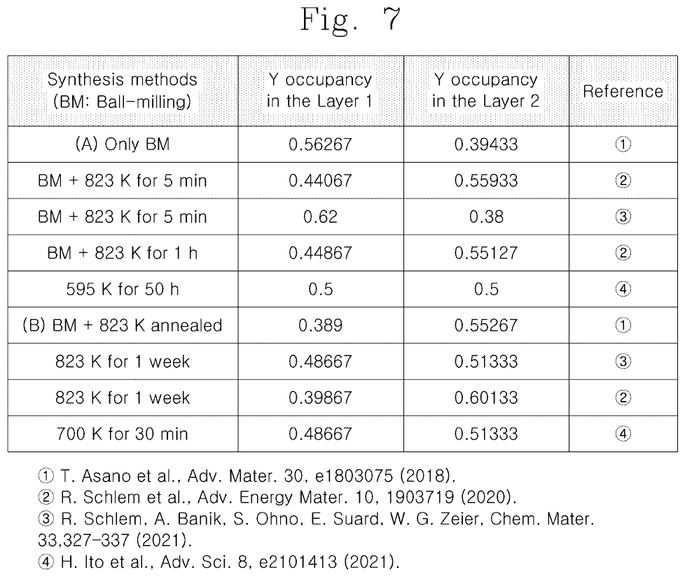

FIG. 7 is a table summarizing the compositions from conventional literature and the literature sources, as plotted in FIG. 6.

The composition of the present disclosure may be expressed by the following composition formula.

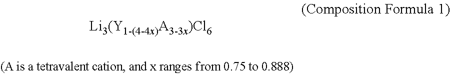

In the present disclosure, A includes at least one element selected from the group consisting of Ti, Zr, Hf, and Rf.

In the present disclosure, the range of the x value may be calculated as follows.

Herein, 1−(4−4x) simplifies 4x−3, and 4x−3≤0 needs to be satisfied, which leads to x≥0.75. In Composition Formula 1, the number of atoms, 4x−3+3−3x, simplifies x, and the value of x is constrained to a minimum of 0.333 and a maximum of 0.888, which correspond to twice the percolation threshold in each layer, 0.167 to 0.444. Therefore, the x value satisfying the two conditions becomes 0.75≤x≤0.888.

As in Composition Formula 1, the composition formula that reflects vacancies created by substituting the trivalent ion with a higher tetravalent ion (A⁴⁺) is as follows.

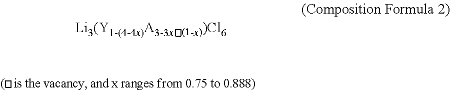

Considering that the charge balance is maintained by, among the number of substituted tetravalent ions, creating vacancies corresponding to some of the substituted ions and decreasing the number of lithium ions corresponding to other of the substituted ions, the composition formula of the present disclosure may be expressed more generally as follows:

### (Composition Formula 3)

Li₃₋ₐ(Y₁₋₍₄₋₄ₓ₎A_{3-3x+(a/4))}Cl₆ (A is the tetravalent cation, x ranges from 0.75 to (0.888−a/4), and a ranges from 0 to 0.552)

The composition formula that reflects on the created vacancies is as follows:

### (Composition Formula 4)

Li_{3-a(Y1-(4-4x)}A_{3-3x+(a/4)D(1-x))}C₆ (A is the tetravalent cation, x ranges from 0.75 to (0.888−a/4), and a ranges from 0 to 0.552)

Composition Formulas 3 and 4, when a representing the reduction ratio of lithium ions is 0, becomes the same as Composition Formulas 1 and 2, respectively.

Hereinafter, experimental examples of the present disclosure will be described in detail.

### Experimental Example 1

To obtain compositions having the composition formulas on Table 1 below, LiCl, YCl₃, and ZrCl₄ were weighed according to the molar ratio of Li, Y, Zr, and CI in the composition formulas, and then the compositions were synthesized by mechanochemical synthesis using a ball mill. As for mechanochemical synthesis conditions for the corresponding synthesis, synthesis was conducted using the Pulverisette 7PL equipment from Fritsch under 800 to 900 rpm, with 10 g of 10 mm ZrO₂ balls and 15 g of 5 mm ZrO₂ balls at a ball to powder ratio 25:1, through a total of 12 steps for 4 hours, with each step involving 15 minutes of milling and 5 minutes of rest.

The composition formulas of this experimental example correspond to the composition formula LiₐMₓCl_{b} in FIG. 6 where x representing the molar ratio of metal ions (M) is 0.8 to 0.888.

To measure the ionic conductivity of each of the synthesized compositions, a symmetrical cell with a SUS/solid electrolyte/SUS structure capable of preventing the deposition and desorption of ions in the electrolyte was used. The solid electrolyte was pelletized by compression under 254 MPa, and AC impedance measurements were conducted using VMP3 by Biologic at a frequency of 3 MHz to 100 MHz under a pressure of 75 MPa.

The ionic conductivity of each composition is shown in Table 1.

TABLE 1

Ionic conductivity (mS/cm)

| Sample | Composition Formula | 800 rpm | 900 rpm |
|---|---|---|---|
| #1 | Li₃Zr_{0.75}Cl₆ | 0.236 | 0.233 |
| #2 | Li₃Y_{0.1}Zr_{0.675}Cl₆ | 0.450 | |
| #3 | Li₃Y_{0.2}Zr_{0.6}Cl₆ | 1.19 | 1.19 |
| #4 | Li₃Y_{0.3}Zr_{0.525}Cl₆ | 0.690 | |
| #5 | Li₃Y_{0.4}Zr_{0.45}Cl₆ | 0.822 | |
| #6 | Li₃Y_{0.5}Zr_{0.375}Cl₆ | 0.818 | |
| #7 | Li₃Y_{0.552}Zr_{0.336}Cl₆ | 1.012 | 1.368 |

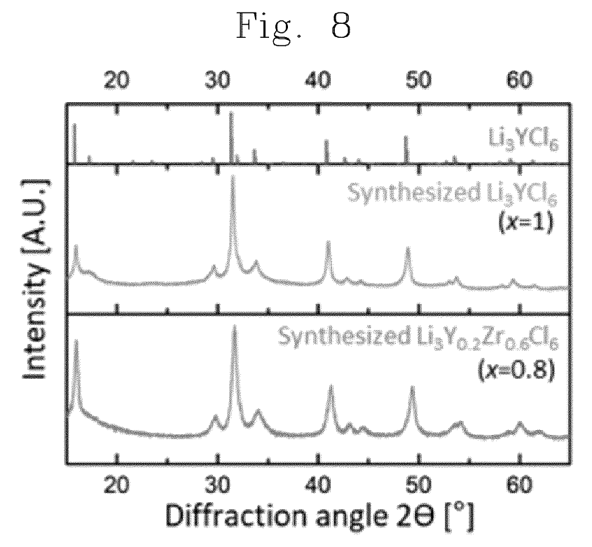

FIG. 8 is a graph showing the results of X-ray diffraction analysis for Sample #3. For comparison, XRD data for Li₃YCl₆ (i.e. x=1) is also plotted. FIG. 8 confirmed that Sample #3 had the same structure as the comparative example, Li₃YCl₆. In addition, the incorporation of Zr⁴⁺ shifted the diffraction pattern to the right, and this result indicates that the addition of Zr⁴⁺, which has a small ionic radius and induces the creation of vacancies, reduced the lattice constant.

### Experimental Example 2

To obtain compositions of the composition formulas on Table 2 below, starting materials were weighed according to the molar ratio of Li, Y, Zr, and CI in the composition formulas, and then the compositions were synthesized. The composition formulas of this experimental example correspond to the compositional formula of LiₐMₓCl_{b} in FIG. 6 where x representing the molar ratio of metal ions (M) is 0.9 or larger.

The ionic conductivity of each of the synthesized compositions is shown in Table 2.

TABLE 2

| | | Ionic conductivity (mS/cm) |
|---|---|---|
| Sample | Composition Formula | 800 rpm |
| #8 | Li₃Y_{0.6}Zr_{0.3}Cl₆ | 0.594 |
| #9 | Li₃Y_{0.7}Zr_{0.22}Cl₆ | 0.506 |
| #10 | Li₃Y_{0.8}Zr_{0.15}Cl₆ | 0.720 |

### Experimental Example 3

To obtain compositions satisfying the composition formulas on Table 3 where the ratio of metal ions was 0.8, starting materials were weighed according to the molar ratio of Li, Y, Zr, and Cl in the composition formulas, and then the compositions were synthesized. The value of “a” in Composition Formula 3 was calculated and shown in the table.

The ionic conductivity of each of the synthesized compositions is shown in Table 3.

TABLE 3

| | Composition | | Ionic conductivity (mS/cm) | |
|---|---|---|---|---|
| Sample | Formula | a | 800 rpm | 900 rpm |
| #11 | Li₃Y_{0.2}Zr_{0.6}Cl₆ | 0 | 1.19 | 1.19 |
| #12 | Li_{2.9}Y_{0.1}Zr_{0.7}Cl₆ | 0.1 | 0.310 | 0.451 |
| #13 | Li_{2.8}Zr_{0.8}Cl₆ | 0.2 | 0.236 | 0.214 |

### Experimental Example 4

To obtain compositions satisfying the composition formulas on Table 4 where the ratio of metal ions was 0.85, starting materials were weighed according to the molar ratio of Li, Y, Zr, and CI in the composition formulas, and then the compositions were synthesized. The value of “a” in Composition Formula 3 was calculated and shown in the table.

The ionic conductivity of each of the synthesized compositions is shown in Table 4.

TABLE 4

| | | | Ionic conductivity (mS/cm) | |
|---|---|---|---|---|
| Sample | Composition Formula | a | 800 rpm | 900 rpm |
| #14 | Li₃Y_{0.4}Zr_{0.45}Cl₆ | 0 | 0.776 | 0.487 |
| #15 | Li_{2.9}Y_{0.3}Zr_{0.55}Cl₆ | 0.1 | 1.203 | 0.708 |
| #16 | Li_{2.8}Y_{0.2}Zr_{0.65}Cl₆ | 0.2 | 0.867 | 0.959 |
| #17 | Li_{2.7}Y_{0.3}Zr_{0.75}Cl₆ | 0.3 | 0.967 | 0.665 |
| #18 | Li_{2.6}Zr_{0.85}Cl₆ | 0.4 | 0.408 | 0.463 |

### Experimental Example 5

To obtain compositions satisfying the composition formulas on Table 5 where the ratio of metal ions was 0.88, starting materials were weighed according to the molar ratio of Li, Y, Zr, and CI in the composition formulas, and then the compositions were synthesized.

The ionic conductivity of each of the synthesized compositions is shown in Table 5.

TABLE 5

| | | | Ionic conductivity (mS/cm) | |
|---|---|---|---|---|
| Sample | Composition Formula | a | 800 rpm | 900 rpm |
| #19 | Li_{2.9}Y_{0.45}Zr_{0.436}Cl₆ | 0.1 | 1.137 | 1.366 |
| #20 | Li_{2.8}Y_{0.35}Zr_{0.536}Cl₆ | 0.2 | 1.401 | 1.403 |
| #21 | Li_{2.7}Y_{0.25}Zr_{0.636}Cl₆ | 0.3 | 0.915 | 0.613 |
| #22 | Li_{2.6}Y_{0.15}Zr_{0.736}Cl₆ | 0.4 | 0.999 | 0.324 |
| #23 | Li_{2.5}Y_{0.05}Zr_{0.836}Cl₆ | 0.5 | 0.692 | |
| #24 | Li_{2.448}Zr_{0.888}Cl₆ | 0.552 | 0.465 | 0.302 |

### B. Secondary Battery Including Halide Solid Electrolyte

A lithium secondary battery according to the present disclosure may include an anode, a cathode disposed to face the anode, and an electrolyte layer between the anode and the cathode. In the secondary battery of the present disclosure, the electrolyte layer may include a separator when the electrolyte layer includes a liquid electrolyte. Additionally, the lithium secondary battery in the present disclosure may optionally further include: a battery case for accommodating an electrode assembly involving the anode, the cathode, and the electrolyte layer; and a sealing member for sealing the battery case.

In the present disclosure, the cathode may include a cathode current collector and a cathode active material layer formed on the cathode current collector.

The cathode current collector is not particularly limited as long as the cathode current collector has conductivity without causing chemical changes in the battery, and, for example, stainless steel, nickel, titanium, fired carbon, or aluminum, or stainless steel that is surface-treated with carbon, nickel, titanium, silver, or the like may be used. The cathode current collector may typically have a thickness of 3 to 500 μm, and fine irregularities can be formed on the surface of the current collector to enhance the adhesion of the cathode active material.

The cathode active material layer may be manufactured by applying a cathode slurry composition containing a conductive material and optionally a binder, together with the cathode active material, onto the cathode current collector.

In the present disclosure, the cathode active material may include a lithium metal oxide capable of electrochemically intercalating or de-intercalating lithium by a redox reaction.

For instance, the cathode active material powder of the present disclosure may be a lithium-containing cobalt-based compound, a lithium-containing nickel-based compound, or a lithium-containing manganese-based compound. The term lithium-containing cobalt-based compound herein may encompass compounds composed of binary cations, ternary cations additionally containing a metal component, such as Ni or Mn, or higher multi-nary cations.

In the present disclosure, the core particle composition may have a layered structure of LiₓNi_{y}CO_{1-z}Mn_{1-y-z}O₂ (0.95≤x≤1.1) containing a ternary cation. A layered structure of NCM has the advantages of having high capacity and high thermal stability.

In the present disclosure, the cathode active material may be a layered structure of multi-nary composition further containing at least one element selected from the group consisting of B, Al, Ga, In, Si, Ge, Sn, Pb, As, Sb, Bi, Ti, V, Cr, Mn, Fe, Co, Ni, Cu, Y, Zr, Nb, Mo, Tc, Ru, Rh, Pd, Ag, Hf, Ta, and W in addition to NCM.

In the present disclosure, the conductive material may employ any conductive material that is known to be usable in lithium secondary batteries or the like, and for example, graphene, carbon nanotubes, Ketjen black, activated carbon, powder-type Super P carbon, rod-type Denka, or vapor grown carbon fiber (VGCF) may be appropriately used.

In the lithium secondary battery of the present disclosure, the anode may include an anode current collector and an anode active material layer disposed on the anode current collector.

The anode current collector is not particularly limited so long as the anode current collector has conductivity without causing chemical changes in the battery. Examples thereof may include copper, stainless steel, aluminum, nickel, titanium, sintered carbon, or copper or stainless steel that is surface-treated with carbon, nickel, titanium, silver, or the like, and aluminum-cadmium alloys. The anode current collector may typically have a thickness of 3 to 500 μm, and like the cathode current collector, fine irregularities can be formed on the surface of the current collector to enhance the adhesion of the anode active material.

The anode active material layer contains an anode active material. The anode active material may include a material capable of electrochemically intercalating or de-intercalating lithium by a redox reaction. For example, the anode active material may be metallic lithium, or a LiAl-based, LiAg-based, LiPb-based, LiSi-based, or LiIn-based alloy resulting from alloying with lithium. Additionally, general carbon materials, such as hard carbon obtained by sintering and carbonizing graphite or a resin, soft carbon obtained by thermally treating cokes, and fullerene may be used, or the anode active material may include silicon, an alloy thereof, silicon oxide, and various other materials.

The conductive material is used to impart conductivity to an electrode, and may include: graphite, such as natural graphite, artificial graphite; carbon-based materials, such as carbon black, acetylene black, Ketjen black, channel black, furnace black, lamp black, thermal black, and carbon fibers; a metal powder or a metal fiber, such as copper, nickel, aluminum, and silver; conductive polymers, such as polyphenylene derivatives, which may be used alone or in a mixture of two or more of the above materials.

Examples of the binder may include polyvinylidene fluoride (PVDF), polyvinyl alcohol, carboxymethyl cellulose (CMC), starch, hydroxypropyl cellulose, regenerated cellulose, polyvinyl pyrrolidone, tetrafluoroethylene, polyethylene, polypropylene, ethylene-propylene-diene polymer (EPDM), sulfonated-EPDM, styrene-butadiene rubber, nitrile-butadiene rubber, fluoro-rubber, and various copolymers thereof.

In the present disclosure, the electrolyte layer may include the above-described halide solid electrolyte.

The solid electrolyte of the embodiment included in the electrolyte layer may be, for example, 10 to 100 vol % or 50 to 100 vol % relative to the volume of the entire electrolyte layer.

The thickness of the electrolyte layer may be, for example, 0.1 to 1000 μm or 0.1 to 300 μm. For example, the electrolyte layer may be manufactured by compressing and molding the solid electrolyte of the embodiment or applying a slurry obtained by mixing the solid electrolyte with a binder and a solvent, followed by drying.

The secondary battery according to another embodiment may be in the form of an all-solid secondary battery, a semi-solid secondary battery, or the like, according to whether an additional liquid or gel electrolyte is included. The secondary battery according to another embodiment can exhibit enhanced ionic conductivity, capacity characteristics, and cycle life characteristics while ensuring excellent safety, by including the solid electrolyte according to an embodiment.

Meanwhile, the examples described in the present specification and drawings are merely the representation of specific examples to aid the understanding, and are not intended to limit the scope of the present disclosure. It would be obvious to a person skilled in the art to which the present disclosure pertains that other modifications based on the technical spirit of the present disclosure in addition to the examples disclosed herein can be implemented.

What is claimed is:

1. A solid electrolyte composition comprising a lithium yttrium halide with a hexagonal close-packed structure, wherein when the occupancy of metal ions is defined as the number of metal ions relative to the number of metal ion sites within two consecutive layers constituting a unit cell with a hexagonal close-packed structure in the halide, the sum of the occupancies of metal ions within the two layers is 0.888 or less.

2. The solid electrolyte composition of claim 1, wherein the occupancy of metal ions within each layer is 0.444 or less.

3. The solid electrolyte composition of claim 1, wherein the halide includes a halide with a hexagonal close-packed structure expressed by Li₃₋ₐ(Y₁₋₍₄₋₄ₓ₎A_{3-3x+(a/4)})Cl₆ (A is a tetravalent cation, x ranges from 0.75 to (0.888-a/4), and a ranges from 0 to 0.552).

4. The solid electrolyte composition of claim 1, wherein A includes at least one element selected from the group consisting of Ti, Zr, Hf, and Rf.

5. The solid electrolyte composition of claim 1, wherein the halide includes (1-x) moles of vacancies in the crystalline structure.

6. A lithium secondary battery comprising a cathode, an anode, and an electrolyte, wherein the electrolyte includes a solid electrolyte composition containing a lithium yttrium halide with a hexagonal close-packed structure, and
wherein when the occupancy of metal ions is defined as the number of metal ions relative to the number of metal ion sites within two consecutive layers constituting a unit cell with a hexagonal close-packed structure in the halide, the sum of the occupancies of metal ions within the two layers is 0.888 or less.

7. The lithium secondary battery of claim 6, wherein the occupancy of metal ions within each layer is 0.444 or less.

8. The lithium secondary battery of claim 6, wherein the halide includes a halide with a hexagonal close-packed structure expressed by Li₃₋ₐ(Y₁₋₍₄₋₄ₓ₎A_{3-3x+(a/4)})Cl₆ (A is a tetravalent cation, x ranges from 0.75 to (0.888-a/4), and a ranges from 0 to 0.552).

9. The lithium secondary battery of claim 6, wherein A includes at least one element selected from the group consisting of Ti, Zr, Hf, and Rf.

10. The solid electrolyte composition of claim 1, wherein the halide includes (1-x) moles of vacancies in the crystalline structure.
